(19) United States
(12) Patent Application Publication
(10) Pub. No.: US 2011/0110833 A1
(43) Pub. Date: May 12, 2011

(54) METHOD AND APPARATUS FOR REMOVING ACID GASES FROM A NATURAL GAS STREAM

(75) Inventors: Stanley Huang, Sugar Land, TX (US); John J. Buckles, The Woodlands, TX (US); Kaman I. Chan, Houston, TX (US)

(73) Assignee: Chevron U.S.A. Inc.

(21) Appl. No.: 12/617,579

(22) Filed: Nov. 12, 2009

(51) Int. Cl. B01D 53/62; F25J 1/00; B01D 53/52

(52) U.S. Cl. 423/228; 62/611

(57) ABSTRACT

A method and apparatus for separating acid gas from a natural gas stream suitable for use on an offshore facility located on a platform or floating vessel are disclosed. The method includes the steps of: contacting the natural gas stream with a semi-lean amine solution in a static mixer to produce a rich amine solution, separating a first portion of carbon dioxide from the rich amine solution to produce the semi-lean amine solution, and heating a portion of the semi-lean amine solution to separate a second portion of carbon dioxide and produce the lean amine solution. The rich amine solution and semi-lean amine solution can be heated using recovered waste heat.

### TECHNICAL FIELD

The invention relates to the removal of acid gases from natural gas streams. More specifically, the invention relates to the removal of carbon dioxide, hydrogen sulfide and/or other potentially corrosive gases that are commonly found in natural gas produced from underground reservoirs.

### BACKGROUND

A traditional, single-stage gas sweetening amine process offers flexibility and high acid gas removal capability needed for natural gas liquefaction facilities. However, its amine regeneration step is heated intensive and usually requires installation of fired heaters to supply the large heat demand. Fired heaters present a high risk ignition source and are not favorable for use in conjunction with LNG facilities either on shore or off shore, e.g., on a platform or floating vessel. To eliminate this safety hazard and to reduce the generation of carbon dioxide, NOx and SOx, a two-stage amine absorber system consisting of semi-lean and lean amine loops has been proposed which is designed with sufficiently low heat requirements to enable operation on recovered waste heat, eliminating the need for fired heaters. Such a system has previously been proposed for floating LNG applications where the produced natural gas has a relatively high carbon dioxide content, for instance as typical of Southeast Asia. This configuration is able to reduce the regeneration heat requirement significantly by splitting the rich amine flow into two closed amine regeneration loops, thus allowing the unit to operate totally on waste heat.

While the two-stage amine absorber system proposed above successfully eliminates the safety hazard and reduces generation of carbon dioxide, NOx and SOx, the system consists of rather complex amine absorber vessels to maintain and control in which even liquid distribution is required. The size and the weight of the absorber vessels are also undesirably large for offshore applications. The two-stage amine absorber system also has a large capital cost requirement.

It would be desirable to simplify the gas sweetening process to minimize the aforementioned disadvantages of known systems.

### SUMMARY

In one embodiment the invention relates to a method for separating acid gas from a natural gas stream, comprising the steps of:

(a) contacting the natural gas stream with a semi-lean amine solution within a static mixer to produce a first rich amine solution;

(b) separating the first rich amine solution within a separator into a second rich amine solution stream and a semi-clean gas stream;

(c) contacting the semi-clean gas stream with a lean amine solution within an amine absorber;

(d) separating a first portion of acid gas from the second rich amine solution stream to produce the semi-lean amine solution by heating the second rich amine solution stream using recovered waste heat or by reducing the pressure on the second rich amine solution stream; and

(e) separating a second portion of acid gas from the semi-lean amine solution to produce the lean amine solution by heating the semi-lean amine solution using recovered waste heat.

Ideally, this method is carried out on an offshore platform or floating vessel.

In another embodiment the invention relates to an apparatus for removing acid gases from a natural gas stream. The apparatus includes an in-line static mixer for mixing natural gas containing acid gases with a semi-lean amine solution to produce a first rich amine solution followed by a separator to separate the rich amine solution into a second rich amine solution stream and a semi-clean gas stream.

It is an object of the method and apparatus disclosed herein to provide enhanced efficiency and reaction rate as compared to a method and apparatus utilizing conventional bulk amine absorbers. It is a further object of the method and apparatus to provide a reduction in apparatus size. It is a still further object of the method and apparatus to reduce plant layout complexity and operating cost.

### BRIEF DESCRIPTION OF THE DRAWINGS

The invention may be understood by reference to the following description taken in conjunction with the accompanying drawing.

FIG. 1 is a schematic representation of an acid gas removal unit of the present invention.

While the invention is susceptible to various modifications and alternative forms, specific embodiments thereof have been shown by way of example in the drawing and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

A two-stage amine absorber system consisting of semi-lean and lean amine loops which is designed with sufficiently low heat requirements to enable operation on recovered waste heat, eliminating the need for fired heaters is described in co-pending U.S. patent application Ser. No. 12/024,273 (Patent Application Publication Number US 2008/0210092 A1), incorporated herein by reference. The application discloses that the waste heat can be recovered from one or more of a land based facility or an off-shore facility located on a platform or floating vessel. The present disclosure describes a system including a preferred static mixer and bulk separator in the first stage of amine absorption having resulting improvements to the system described in co-pending U.S. patent application Ser. No. 12/024,273.

The static mixer provides such rigorous contact between the liquid and gaseous phases that continuous and distinguishable bulk phases cease to exist. The results of this mixing include very high efficiency of reaching thermodynamic equilibrium, and obviating the need to control the flow patterns within the mixer.

The bulk separator provides an enclosed space such as a drum in which gas and liquid are allowed to separate. The bulk separator does not require control of the flow pattern within the separator. The internal surface of the separator may include baffles which can help to stabilize the distribution of fluid within the separator. The bulk separator may also include an optional liquid distributor which can help to direct liquid flow into and within the separator.

The static mixer/bulk separator combination eliminates the need for maintaining desirable flow patterns by regulating relative flow rates of the two phases as well as the need for installation of liquid distributors as are required with the use of a conventional amine absorber.

The present system is particularly useful for removing carbon dioxide from streams having a relatively high concentration of carbon dioxide such as where the natural gas stream contains at least about 7 mol % carbon dioxide, in some cases at least 7.5 mol % carbon dioxide, and in still others, at least about 8 mol % carbon dioxide.

An amine absorber system is presented which is designed with sufficiently low heat requirements to enable operation on waste heat only. This allows elimination of fired heaters, or at least minimizes their presence, greatly improving safety of floating LNG (FLNG) applications using high CO2 feed gas (containing up to 15 mole %, especially containing more than 7.5 mole % CO2). As described in co-pending U.S. patent application Ser. No. 12/024,273, the waste heat useful for heating the amine solutions of the system can be recovered from one or more of a turbine, compressor, and compressor driver. A first portion of carbon dioxide can be separated from the rich amine solution by heating the rich amine solution. The heat can be provided to the rich amine solution in a flash vessel from an overhead stream of a stripper column, the stripper column having a reboiler heated with the recovered waste heat. Similarly, the semi-lean amine solution can be heated in a stripper column. Heat can be provided to the stripper column through a reboiler heated with the recovered waste heat. Optionally, the rich amine solution can be flashed in a flash vessel to remove hydrocarbon vapor before separating the first portion of carbon dioxide from the rich amine solution. By “lean amine” solution is meant amine not including acid gas. “Semi-lean” refers to a solution of 10-70 weight percent amine in water. By “rich amine” is meant that the solution is fully loaded with acid gas.

The heat load can be reduced by having the majority of the regeneration done simply by pressure release at low pressure (typically 10-100 bar, although 10-200 bar is possible) with the stripper overhead vapor as energy source. This semi-lean solvent is used for bulk acid gas removal. A small amount of the semi-lean solution is fed to the stripper to obtain very low CO2 loading and is used as polishing agent to ensure tight gas specification can be met.

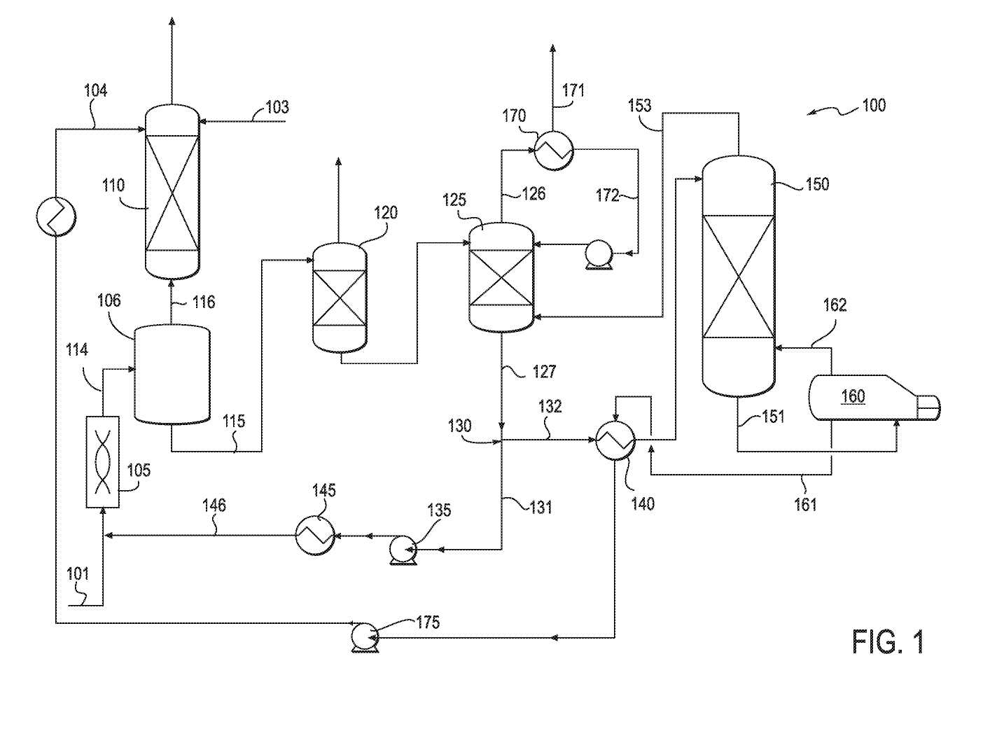

FIG. 1 shows the schematic of a two-stage absorber process located on an offshore platform or floating vessel. For this two-stage process design, the bulk solvent regeneration is achieved first by pressure reduction to a high pressure (generally less than about 30% of the inlet pressure) flash vessel with the stripper overhead vapor as the energy source. About 87 percent of the semi-lean solution leaving the bottom of this vessel will be recycled back to the static mixer and bulk separator for bulk acid gas removal. Those skilled in the art will appreciate the present invention can also be used onshore if so desired.

The semi-clean gas stream leaving the bulk separator typically contains approximately 3 to 4 mole % of CO2 and requires further treating. The rest of the semi-lean solution not recycled back to the bulk separator will be fed to the stripper for regeneration in order to achieve very low lean amine loading. After regeneration, the lean solution is then sent to the lean absorber as polishing agent to ensure that the natural gas specification can be met.

A low acid gas pressure at the low pressure flash vessel advantageously results in lower CO2 partial pressure at the bottom of the vessel, thus allowing more CO2 to be absorbed per cubic meter of circulated solvent.

High-pressure flash is included in the system to remove most of the dissolved and entrained gases from the amine solvent and to ensure that tight acid gas specification can be met. This is desirable if the acid gas (CO2) is subject for re-injection. The amount of high pressure flash gas is more than a traditional single-stage process because of the large solvent circulation rate. This high-pressure flash gas can be used as fuel gas onboard of the FLNG.

### DETAILED DESCRIPTION OF THE FIGURE

FIG. 1 is a schematic representation of apparatus 100 that includes static mixer 105 and bulk separator 106. Static mixer 105 has an inlet for feed gas 101 and semi-lean amine solution 146. The feed gas flows through the static mixer 105 where the feed gas contacts the semi-lean amine solution 146, and a stream 114 rich in carbon dioxide and other acid gases is formed. This first rich amine stream 114 flows into the bulk separator 106 where the first rich amine stream 114 further contacts an amine solution. Carbon dioxide and other acid gases are absorbed from the first rich amine stream 114 into the amine solution. A second rich amine stream 115 is separated and removed from the bottom of the bulk separator 106. The second rich amine stream 115 is rich in carbon dioxide and other acid gases and may contain some dissolved or entrained hydrocarbons. A semi-clean gas stream 116 passes from the top of the bulk separator 106 to a lean absorber 110 where the semi-clean gas stream 116 contacts an amine solution. Lean amine solution 104 and make up water 103 are fed to the lean absorber 110. The make up water 103 replenishes the water lost in the process.

Second rich amine solution 115 is directed from the bulk separator 106 to high pressure flash vessel 120 where the high pressure flashing causes dissolved and entrained hydrocarbons to separate from the solution and pass out of the flash vessel as an overhead vapor stream. Because this is a high pressure flash, most of the acid gases in the rich amine stream remain in the liquid phase. The overhead stream coming off flash vessel 120 can be used for a variety of purposes such as fuel gas in associated equipment and facilities.

The bottom stream coming off high pressure flash vessel 120 is directed to low pressure flash vessel 125. Flash vessel 125 receives heat in the flow of overhead vapor 153 from stripper column 150. The combination of the pressure drop and heat within the flash vessel 125 enables dissolved and entrained acid gases to separate and evolve producing semi-lean amine solution 127. The carbon dioxide content of the semi-lean amine solution will depend in part on the carbon dioxide content of the feed gas. Where the carbon dioxide content of the feed gas is about 14 mol % or more, the carbon dioxide content of the semi-lean amine solution should be less than about 5 mol %, and in some cases less than about 4 mol %. The overhead stream 126 is directed to reflux condenser 170. The acid gases 171 exiting condenser 170 can be sequestered or stored for additional handling or processing (not illustrated).

The semi-lean amine solution 127 is split into first and second portions by flow splitter 130. First portion 131 is larger than second portion 132, generally in a ratio of at least about 4:1 as described above. The first portion 131 of the semi-lean amine solution is then pumped into static mixer 105 for contacting with the feed gas 101. The bulk of carbon dioxide in the feed gas is removed between the static mixer 105 and the bulk absorber 106.

The second portion of semi-lean amine solution 132 is directed through heat exchanger 140 and then to stripper column 150. Reboiler 160 is heated with hot oil derived from liquefaction compressor drivers (not illustrated) and this heat is used to heat the semi-lean amine solution in stripper column 150. The carbon dioxide in this semi-lean amine solution is separated and reduced to produce a lean amine solution 161 having a carbon dioxide content of less than about 1 mol %, in some cases less than about 0.5 mol %, and in still other cases less than about 0.2 mol %. Lean amine solution 161 is then directed to the top of lean absorber 110 for contacting with the semi-clean gas stream 116 flowing up from the bulk separator.

The two-stage amine absorber system disclosed herein uses recovered waste heat to safely remove acid gases prior to natural gas liquefaction. The use of a static mixer in such a system enables several advantages for offshore LNG applications over known systems, including lower cost, lower weight, more compact size, ease of maintenance and the elimination of the need for complex liquid distribution within absorber vessels.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for separating acid gas from a natural gas stream, comprising the steps of:
(a) contacting the natural gas stream with a semi-lean amine solution within a static mixer to produce a first rich amine solution;
(b) separating the first rich amine solution within a separator into a second rich amine solution stream and a semi-clean gas stream;
(c) contacting the semi-clean gas stream with a lean amine solution within an amine absorber;
(d) separating a first portion of acid gas from the second rich amine solution stream to produce the semi-lean amine solution by heating the second rich amine solution stream using recovered waste heat or by reducing the pressure on the second rich amine solution stream; and
(e) separating a second portion of acid gas from the semi-lean amine solution to produce the lean amine solution by heating the semi-lean amine solution using recovered waste heat.

2. The method of claim 1, wherein steps (a) through (e) are conducted on an offshore platform or floating vessel.

3. The method of claim 1, wherein the waste heat is recovered from one or more of a turbine, compressor, and compressor driver.

4. The method of claim 1, wherein the second rich amine solution stream is heated by providing heat to the second rich amine solution stream in a flash vessel from an overhead stream of a stripper column, the stripper column having a reboiler heated with the recovered waste heat.

5. The method of claim 1, wherein the semi-lean amine solution is heated in a stripper column.

6. The method of claim 4, wherein heat is provided to the stripper column through a reboiler heated with the recovered waste heat.

7. The method of claim 1, wherein the natural gas stream contains at least about 7 mol % carbon dioxide before contacting the semi-lean amine solution.

8. An apparatus for liquefying a natural gas stream, the apparatus comprising:
a liquefaction unit having a heat generating unit; and
an acid gas treating unit connected to the liquefaction unit having:
a static mixer for contacting a natural gas stream with a semi-lean amine solution to remove carbon dioxide from the natural gas stream and produce a first rich amine stream;
a separator for separating the first rich amine solution into a second rich amine solution stream and a semi-clean gas stream;
an amine absorber for contacting the semi-clean gas stream with a lean amine solution;
a first flash vessel connected to the amine absorber for separating a first portion of acid gas from the rich amine solution to produce the semi-lean amine solution; and
a stripper column connected to the flash vessel for separating a second portion of carbon dioxide from a portion of the semi-lean amine solution to produce the lean amine solution;
wherein the stripper column is connected to the heat generating unit for receiving heat therefrom.

9. The apparatus of claim 8, wherein one or more of the liquefaction unit and the acid gas treating unit is located off-shore on a platform or floating vessel.

10. The apparatus of claim 8, wherein the heat generating unit comprises one or more of turbine, compressor, and compressor driver.

11. The apparatus of claim 8, wherein the heat generating unit does not comprise a fired heater.
